(19) United States
(12) Patent Application Publication
(10) Pub. No.: US 2010/0077112 A1
(43) Pub. Date: Mar. 25, 2010

(54) DATA STORAGE MANAGEMENT SYSTEM AND METHOD THEREOF

(75) Inventor: YI-TA CHIANG-LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,893

(22) Filed: Dec. 31, 2008

(30) Foreign Application Priority Data
Sep. 19, 2008 (CN) 200810304577.6

(51) Int. Cl. G06F 3/00

(52) U.S. Cl. 710/53

(57) ABSTRACT

The present disclosure provides a management system and method for data storage. A storage management system comprising a plurality of data output units, a plurality of buffers, a memory, and a processor. The plurality of buffers correspond to the data output units is coupled to the data output units respectively and configured for storing data outputted from the data output units temporarily. The processor comprises a selecting module, a memory apportioning module, a copy module, and a writing module. The selecting module is electrically coupled to the plurality of buffers, and is configured for selecting a buffer from the plurality of buffers as a combined buffer. The memory apportioning module is electrically coupled to the combined buffer, and is configured for leaving out a memory paragraph in the combined buffer. The copy module is electrically coupled to the plurality of buffers, and configured for copying the data in the rest of the buffers into the memory paragraph of the combined buffer. The writing module is electrically coupled to the combined buffer and the memory, and configured for writing the data stored in the combined buffer into the memory.

### BACKGROUND

1. Technical Field

The present disclosure relates to data storages and, particularly, to a data storage management system and a data storing method thereof.

2. Description of the Related Art

Memory cards are more and more widely used in various types of devices. Such devices include digital music players, digital still cameras, personal digital assistants (PDAs), video cameras, cellular phones, and other digital consumer electronic products.

In a typical storage management system, image and voice data obtained by an image sensor and a microphone need to be temporarily stored in separate buffers. And then, each buffer needs a write operation to write the image data and the voice data into a memory card in turn. However, because each write operation includes an addressing process, the process of storing the image and voice data into the memory becomes very time-consuming.

What is needed, therefore, is a storage management system and a storing method thereof to overcome the above-described problem.

### BRIEF DESCRIPTION OF THE DRAWINGS

Many aspects of the present storage management system and storing method can be better understood with reference to the following drawings. The components in the drawings are not necessarily drawn to scale, the emphasis instead being placed upon clearly illustrating the principles of the present storage management system and storing method.

FIG. 1 is a functional block diagram of a storage management system according to an exemplary embodiment.

FIG. 2 is a functional block diagram of a processor of the storage management system of FIG. 1 according to the exemplary embodiment.

FIG. 3 is a flowchart of a storing method according to an exemplary embodiment.

### DETAILED DESCRIPTION OF THE EMBODIMENTS

Embodiments of the present disclosure will now be described in detail below, with reference to the accompanying drawings.

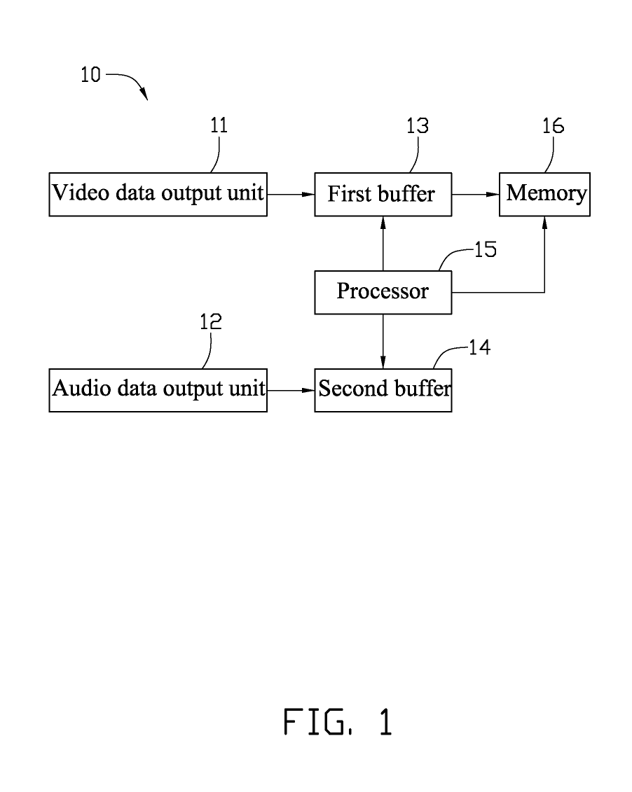

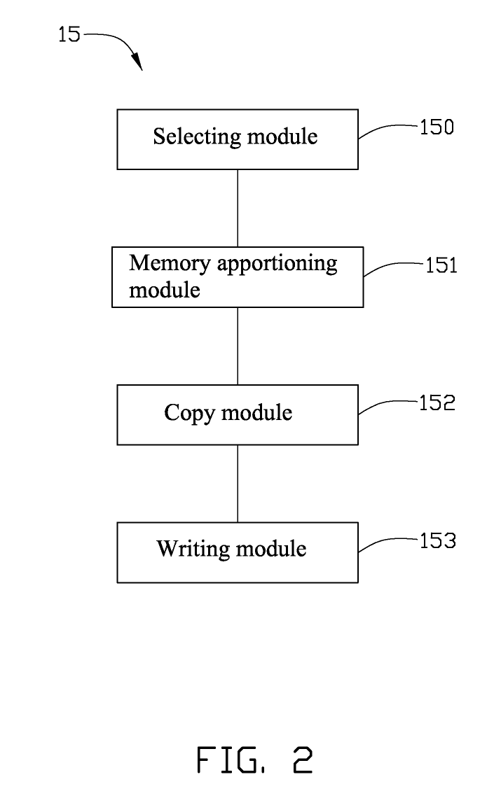

Referring to FIGS. 1 and 2, a storage management system 10, according to an exemplary embodiment, is shown. The storage management system 10 can be used in various electronic devices, such as a digital camera, a digital video camera, or a cell phone (not shown). The storage management system 10 includes a video data output unit 11, an audio data output unit 12, a first buffer 13, a second buffer 14, a processor 15, and a memory 16. The storage management system 10 can include more than two buffers and data output units. In the present embodiment, the storage management system 10 includes two buffers and two data output units. The memory 16 can be a Secure Digital Memory (SD) Card, a Smart Media (SM) card and so on. In the present embodiment, the memory 16 is an SD card.

The video data output module 11 is electrically coupled to the first buffer 13 and is configured for outputting video data to the first buffer 13. The audio data output module 12 is electrically coupled to the second buffer 14 and is configured for outputting audio data to the second buffer 14. The format of the audio and video data may be Audio Video Interleaved (AVI) or Moving Pictures Experts Group (MPEG). In the present embodiment, the format is AVI. In order that the video data output module 11 and the audio data output module 12 can output data synchronously, the first buffer 13 and the second buffer 14 need to store data synchronously. The first buffer 13 is used for temporarily storing the video data sent from the video data output module 11. The second buffer 14 is used for temporarily storing the audio data sent from the audio data output module 12.

The processor 15 is electrically coupled to the first buffer 13 and the second buffer 14, and is configured for managing the data in the first buffer 13 and the second buffer 14. The processor 15 includes a selecting module 150, a memory apportioning module 151, a copy module 152, and a writing module 153.

The selecting module 150 is electrically coupled to the first buffer 13 and the second buffer 14, and is configured for selecting one of the first buffer 13 and the second buffer 14 to be used as a combined buffer. The selecting module 150 can select any buffer as the combined buffer. In the present embodiment, when recording an AVI file, the amount of video data will be greater than that the amount of audio data, therefore the rate of copying the audio data into the first buffer 13 by the processor 15 is quicker than copying the video data into the second buffer 14. In the present embodiment, because it takes less time to copy the audio data stored in the second buffer 14 than into the first buffer 13, the selecting module 150 selects the first buffer 13 to be the combined buffer.

The memory apportioning module 151 is electrically coupled to the first buffer 13, and is configured for reserving a memory paragraph in the combined buffer. In the present embodiment, the memory apportioning module 151 reserves a memory paragraph in the first buffer 13. The capacity of the memory paragraph is substantially equal to amount of the audio data to be recorded in a second, and the format of the audio data is AVI. In the present embodiment, the amount of video data recorded in one second is 16008 bytes. Therefore, the capacity of the memory paragraph is 16008 bytes.

The copy module 152 is electrically coupled to the first buffer 13 and the second buffer 14, and configured for copying the data into reserved memory paragraph of the combined buffer from the remaining buffers, which in this embodiment is the second buffer 14. The copy module 152 can copy the data buffered for a predetermined period of time or until a predetermined amount of data is copied. In the present embodiment, the first buffer and second buffers 13, 14 both store one second worth of video and audio data a time, so the copy module 152 copies all of the one second worth of audio data in the second buffer 14 to the memory paragraph in the first buffer 13.

The writing module 153 is electrically coupled to the first buffer 13 and the memory 16, and configured for writing the data stored in the combined buffer into the memory 16. In the present embodiment, the writing module 153 can write the data stored in the first buffer 13 into the memory 16.

In accordance with the exemplary embodiment, the storage management system 10 copies the data from all but one buffer into a combined buffer first, then writes all the data stored in the combined buffer into a memory. Thus the number of write operations between the buffers and the memory are decreased, accordingly, the number of addressing processes corresponding to write operations are also decreased. As a result, it takes relatively less time to store audio and video data into the memory 16.

In a contrasting experiment, a general storage management system was used to store an AVI file in a 32 MB Toshiba SD card. The storing speed achieved was 1.0 MB/s. Whereas when the present exemplary storage management system was used to store the same AVI file using the same 32 MB Toshiba SD card, the storing speed achieved was 1.2 MB/s. The storing speed was observably improved.

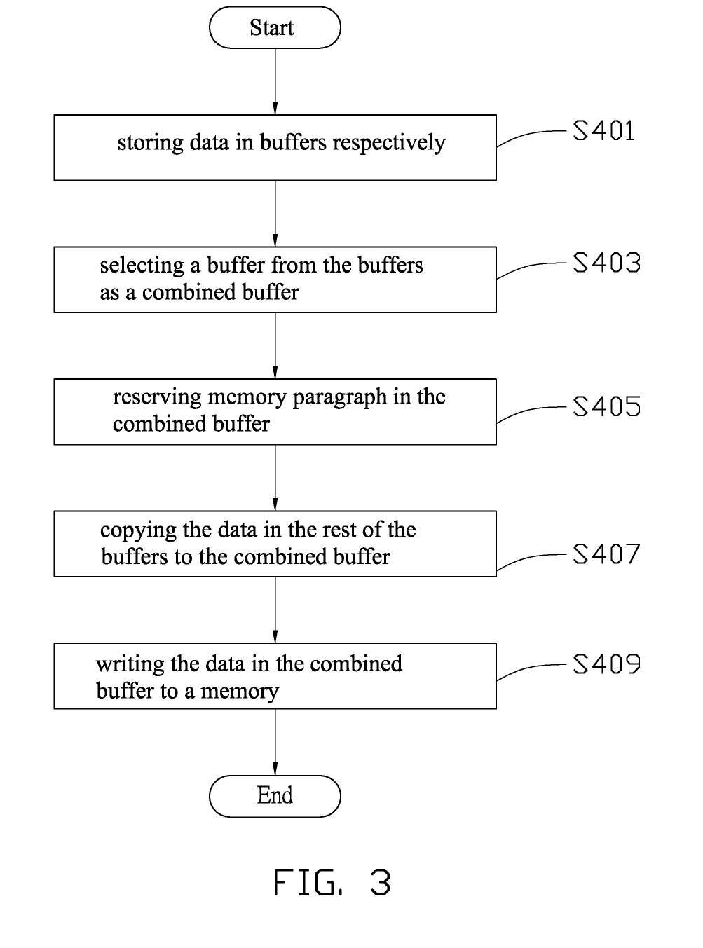

Referring to FIG. 3, a data storing method of the storage management system 10 including a number of buffers and a memory is shown. The method includes the following steps.

Step S401, storing data in the buffers respectively. In the present embodiment, the first buffer 13 is used for temporarily storing the video data sent from the video data output module 11. The second buffer 14 is used for temporarily storing the audio data sent from the audio data output module 12.

Step S403, selecting a buffer from the number of buffers to use as a combined buffer. In the present embodiment, the selecting module 150 selects the first buffer 13 for use as the combined buffer.

Step S405, reserving a memory paragraph in the combined buffer which is buffer 13. In the present embodiment, the amount of video data recorded in one second is 16008 bytes, therefore the capacity of the memory paragraph is 16008 bytes.

Step S407, copying the data into the combined buffer from the remaining buffers, which in this embodiment is the second buffer 14. The copy module 152 can copy the data by many modes. For example, the copy module 152 can copy the data recorded during a certain time period such as one second or until a predetermined amount of data has been copiedty.

Step S409, writing the data in the combined buffer to the memory. In the present embodiment, the writing module 153 writes the data stored in the first buffer 13 to the memory 16.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A storage management system comprising:
a plurality of data output units;
a plurality of buffers corresponding to the plurality of data output units each coupled to the data output units respectively and configured for storing data outputted from the corresponding data output unit temporarily;
a memory; and
a processor comprising:
a selecting module electrically coupled to the plurality of buffers, and configured for selecting a buffer from the plurality of buffers as a combined buffer;
a memory apportioning module electrically coupled to the combined buffer, and configured for leaving out a memory paragraph in the combined buffer;
a copy module electrically coupled to the plurality of buffers, and configured for copying the data in the rest of the buffers into the memory paragraph of the combined buffer; and
a writing module electrically coupled to the combined buffer and the memory, and configured for writing the data stored in the combined buffer into the memory.

2. The storage management system as claimed in claim 1, wherein the copy module copies the data in the rest of the buffers into the memory paragraph in a certain interval.

3. The storage management system as claimed in claim 1, wherein the copy module copies the data in the rest of the buffers into the memory paragraph until the capacity of the data reaches a predetermined capacity.

4. The storage management system as claimed in claim 1, wherein the memory is a memory card.

5. The storage management system as claimed in claim 1, wherein the storage management system is used in a digital image recording device.

6. The storage management system as claimed in claim 2, wherein the plurality of data output units are a video data output unit and an audio data output unit, the plurality of buffers includes a first buffer and a second buffer, the first buffer is coupled to the video data output unit and configured for storing the video data temporarily, the second buffer is coupled to the audio data output unit and configured for storing the audio data temporarily.

7. The storage management system as claimed in claim 6, wherein the format of the video data and audio data is Audio Video Interleaved or Moving Pictures Experts Group.

8. A data storing method of a storage management system which comprising a plurality of buffers and a memory, the method comprising:
selecting a buffer from the plurality of buffers as a combined buffer;
reserving memory paragraph in the combined buffer;
copying the data stored in the rest of the buffers into the combined buffer;
saving the copied data into the memory paragraph of the combined buffer.

9. The method as claimed in claim 8, wherein the data is copied from the rest of the buffers in a certain interval.

10. The method as claimed in claim 11, wherein the data is copied in the rest of the buffers until the capacity of the data reaches a predetermined capacity.

11. The method as claimed in claim 8, further comprising the step of: storing data in the buffers respectively before the selecting step.

12. The method as claimed in claim 8, further comprising the step of: writing the data in the memory paragraph of the combined buffer to the memory of the storage management system.
